(19) United States
(12) Patent Application Publication
(10) Pub. No.: US 2002/0099576 A1
(43) Pub. Date: Jul. 25, 2002

(54) Managing reservations

(76) Inventors: John A. MacDonald, Westford, MA (US); Gregory S. Davis, Boston, MA (US); Bradford Meiseles, Natick, MA (US)

Correspondence Address: DAVID L. FEIGENBAUM, FISH & RICHARDSON P.C., 225 Franklin Street, Boston, MA, 02110-2804, US

(21) Appl. No.: 09/766,945

(22) Filed: Jan. 22, 2001

(51) Int. Cl. G06F 17/60

(52) U.S. Cl. 705/6; 705/5

(57) ABSTRACT

Systems and methods are provided for managing reservations, e.g., reservations for units in lodging facilities such as cabins on cruise ships and rooms or suites in hotels, using the Internet. A person wishing to make a reservation can easily access information regarding the availability of units (e.g., cabins or rooms) during a particular time period by visiting a website that includes plans showing various areas of a place of accommodation (e.g., a deck of a ship or floor of a hotel).

### TECHNICAL FIELD

This invention relates to managing reservations.

### BACKGROUND

When a person wishes to make a reservation for travel accommodations, for example a cabin on a cruise ship or a room in a hotel, generally the person consults a travel agent or the owner of the accommodations and discusses the nature of the cabins or rooms that are available during a given time period. This may be done in person, but is often done over the telephone. In some cases, the person can use the Internet to consult a hotel's website when making hotel reservations and obtain some information regarding availability. This information is typically in the form of a list of the types of rooms that are available during the time period. If the person wishes to obtain information on the availability of units in a number of different ships or hotels, it is generally necessary for the person or the travel agent to contact each accommodation provider individually.

In the case of reserving seats in a theatre or stadium, the person making a reservation may be able to look at a diagram of the seating arrangement and discuss the desirability of available seats with a reservation-taker.

In the case of cruise ship reservations, each ship has a number of decks, each deck has different types of cabins that are arranged in a particular configuration, and each ship in a fleet may have an arrangement of decks and cabins that is different from other ships in the fleet. The ships of different fleets also typically have different arrangements of decks and cabins. As a result, if a traveler wishes to compare various cruise ships and consider different possible travel dates, many options will need to be investigated and presented to the traveler by the person managing the reservations for the cruise line.

### SUMMARY

The present invention provides systems and methods for managing reservations, e.g., reservations for units in lodging facilities such as cabins on cruise ships and rooms or suites in hotels, using the Internet. The invention allows a person wishing to make a reservation to easily access information regarding the availability of units (e.g., cabins or rooms) during a particular time period by visiting a website that includes plans showing various areas of a place of accommodation (e.g., a deck of a ship or floor of a hotel). Because the user can view a plan of the place of accommodation, the user can easily compare the relative desirability of various units, for example by observing how close the unit is to an elevator or shared bathroom. In some implementations, the website includes plans for many different places of accommodation having different configurations of units. The invention also allows a person in charge of managing reservations to provide travelers (or others wishing to make reservations) with easy access to continuously updated information concerning availability of units. In some implementations, the website provides the user with information regarding the cost and features of particular units.

In one aspect, the user interactively enters a time period of interest and then views a plan showing an area of the place of accommodation (e.g., a deck of a ship or floor of a hotel) that includes an indicator, displayed in the vicinity of each of the units, showing whether that unit is available during the time period. In some implementations, by clicking on a particular unit, the user can obtain information on the features of that unit, which may include a graphic image of a portion of the unit.

In one aspect, the invention features a method including (a) displaying a plan of units located at a place of accommodation, (b) receiving from a user an interactive indication of a calendar period of interest, (c) receiving continually updated information about the availability for booking, during specified calendar periods, of units displayed on the plan, and (d) using the updated information to display in the vicinity of units on the plan an indicator of the availability state of units during the calendar period of interest. Implementations of this aspect of the invention may include one or more of the following features. The method includes displaying one indicator per unit. The display is on a web browser. The place of accommodation includes a lodging facility, for example a cruise ship or hotel. The units include cabins on a cruise ship, or rooms or suites in a hotel. The plan includes an image of a deck of a cruise ship, or an image of a floor of a hotel. The method further includes displaying a graphic image of the interior of a unit when the user moves a pointer over the unit on the plan. The method further includes displaying textual information relating to features of a unit when the user moves a pointer over the unit on the plan. The plan includes a seating arrangement. The seating arrangement is in a theatre, stadium or restaurant.

In another aspect, the invention features a method including (a) obtaining at least one plan of units for each of multiple places of accommodation, the different places of accommodation having different configurations, (b) making the plans of units available through a publicly accessible electronic network, (c) receiving continually updated information concerning the availability state of each of the units displayed on each plan during specified time periods, and (d) making the updated information available through the network so that it can be accessed by a user while viewing any of the plans of units.

Implementations of this aspect of the invention may include one or more of the following features. The network includes the Internet. The places of accommodation include lodging facilities. The method further includes using the updated information to display an indicator in the vicinity of units on the plan of the availability state of units during a calendar period of interest. The plans of units include electronic representations of cruise ship decks.

In a further aspect, the invention features a method including (a) obtaining an electronically represented plan of units for a place of accommodation, (b) displaying the plan, and (c) enabling a developer to interactively associate coordinates with each unit of the plan, to identify hot spots on which a user can position a pointer to obtain information associated with each unit. The information may include a graphic image of the interior of a unit, and/or textual information relating to features of a unit, and may be provided in a popup window.

In yet another aspect, the invention features a method including (a) displaying, on a web browser, a plan of units located at a lodging facility, (b) receiving an interactive indication from a user of a calendar period of interest, (c) receiving continually updated information about the availability for booking of units displayed on the plan during specified calendar periods, and (d) using the updated information to display one indicator per unit in the vicinity of units on the plan of the availability state of units during the calendar period of interest.

The invention also features a method including displaying a plan of units located at a place of accommodation, and displaying a graphic image of the interior of a unit when a user moves a pointer over the unit on the plan.

In another aspect, the invention features a method including (a) at a server, storing plans of accommodations available at different locations, (b) receiving at the server continually updated information about the availability of the accommodations at the different locations during defined time periods, and (c) making the plans and the continually updated information available on a publicly accessible communication network to customers for the accommodations.

The invention also features a web page, including a plan of units of accommodation at a location, and indicators on the plan in the vicinity of units of the accommodation, the indicators indicating the availability states of the units.

The phrase “place of accommodation”, as used herein, includes any facility that offers a number of units (e.g., seats, rooms, cabins or other spaces) that are in the same vicinity but have different individual locations, and that can be individually reserved for a specified time period. At least some of the units differ from other units, e.g., in price and/or desirability.

The term “lodging facility” refers to any place that provides overnight accommodation, including cruise ships, hotels and campgrounds.

The term “hotel”, as used herein, includes lodging facilities that offer rooms or suites at daily or weekly rates, including motels, motor inns, bed and breakfasts, inns, and condominiums available on a short-term rental basis.

The term “publicly accessible”, as used herein, means accessible to at least a portion of the public, for example to travel agents, or to the public at large.

Other features and advantages of the invention will be apparent from the description and drawings, and from the claims.

### DESCRIPTION OF DRAWINGS

FIG. 1 is a schematic block diagram of a system for managing reservations.

FIGS. 2-4 are screenshots of webpages that are viewed by a user checking the availability of cabins on a cruise ship.

FIGS. 5-9 are screenshots of an application used by a developer to produce webpages such as those shown in FIGS. 2-4.

FIG. 10 is a plan of a hotel floor.

FIGS. 11 and 11A are plans showing seating arrangements in a theater, and FIG. 12 is a plan showing a seating arrangement in a stadium.

### DETAILED DESCRIPTION

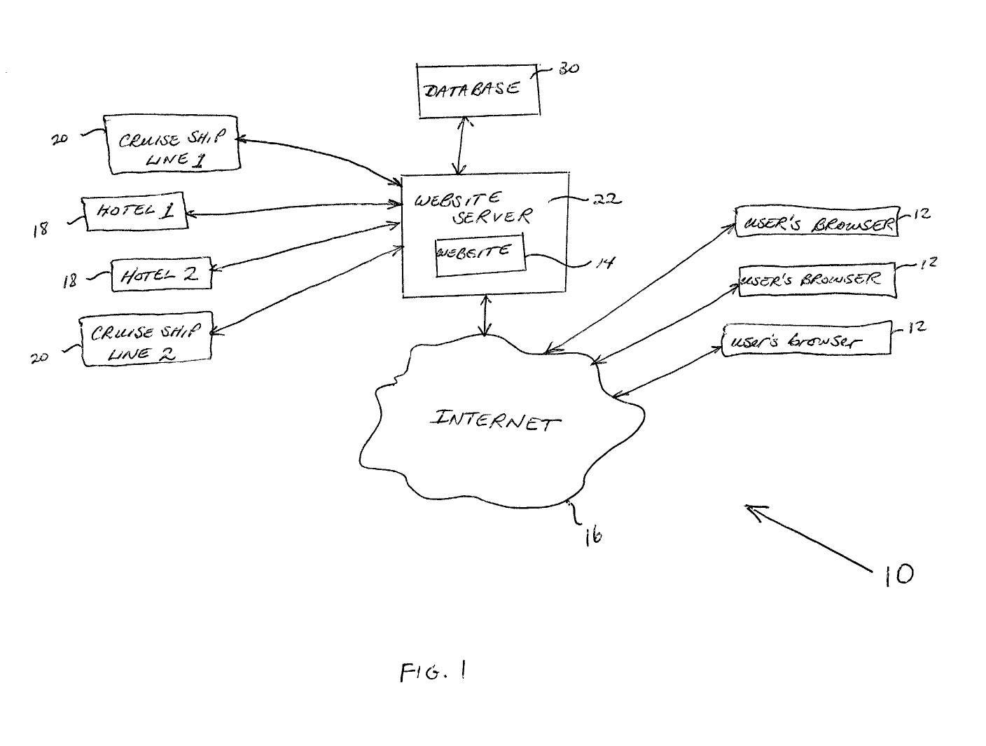

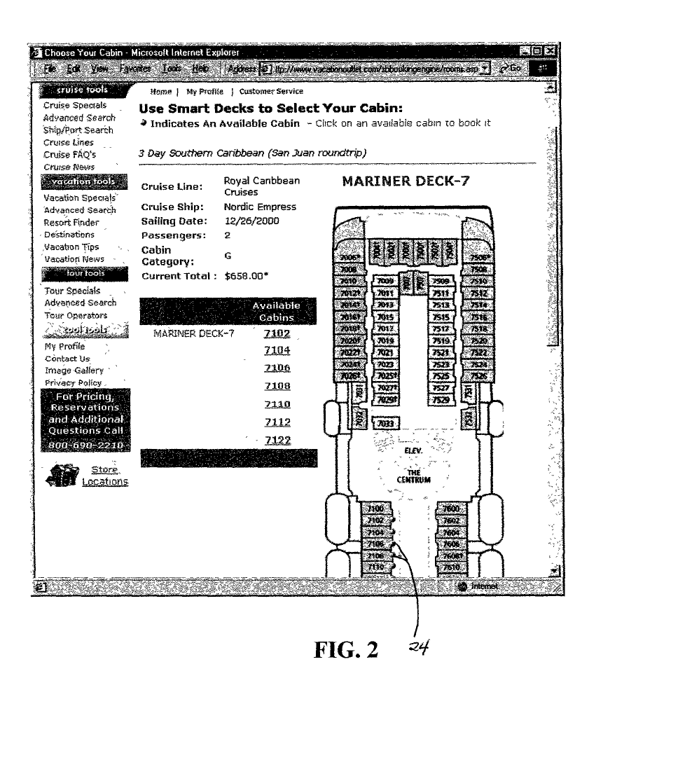

FIG. 1 shows a system 10 by which reservation makers are able to check on the availability of units at a place of accommodation over the Internet. Using a standard web browser 12, e.g., Internet Explorer, users (reservation makers) can connect to a website 14 (operated by a website server 22) via the Internet 16. The website server has application software programmed to implement reservation managing functions, examples of which will be described below with reference to FIGS. 2-4. Reservation takers, for example, owners or agents of hotels 18 or cruise ship lines 20, provide plans showing the arrangement of units for which reservations can be accepted to the website server 22. Developers use an application running on the website server 22 to interactively associate coordinates with each unit on an electronically represented version of the plan, to identify hot spots on which a user can position his mouse to obtain information concerning the unit. The developers also interactively associate coordinates with each unit to identify the location where an indicator may be displayed to indicate the availability state of the unit. The reservation takers also provide the website server with continuously updated information concerning the availability state of the units. This information is also associated with the units on the electronically represented version of the plan, and indicators are provided next to individual units to provide a visual indication of the availability state of the units when the plan is displayed on a webpage on the website.

Using the System to Check Availability

When a user visits the website 14, he is prompted to enter a calendar period of inquiry (dates for which the user wishes availability information). Once a calendar period of inquiry specification is received from the user's web browser, a deck plan diagram is rendered, as shown in FIG. 2. The deck plan diagram displays the location of all the deck's cabins and adds a special notation (e.g., a red light 24, as shown in FIG. 2) to each cabin representation that corresponds to a cabin that is available for reservation. The notation is typically an indicator that blinks different colors, so as to contrast with the plan and be readily visible regardless of the background color.

In the example shown in FIG. 2, the calendar period of inquiry for cabin reservation availability is “Sailing Date: 12/26/2000.” This date (the date indicated by the user's web browser) has been compared by the web server 22 against information provided by the appropriate cruise ship line 20 to generate the schematic diagram of the “Mariner Deck” of Royal Caribbean Cruise Line's Nordic Empress. The schematic diagram is preloaded with a graphical indication of reservation availability for each cabin shown. The dynamic graphical indication of reservation availability is compatible with widely used web browser software and is based on real time data received from respective cruise line reservation systems. For example, the software system of a cruise line is issued an information request by the website server 22, requesting the most current reservation availability status for the cabins shown on the “Mariner Deck” for use in this single web page rendering. Communication between the website server and the software system of the cruise line is generally over a point-to-point connection, using a TCP/IP protocol.

The display reports additional reservation information and descriptive information for any shown cabin in response to a request from the web browser user. The reports are made by continually updating the display with a cabin availability status message and cabin description message in the vicinity of the web browser user's indicated cabin on the diagram.

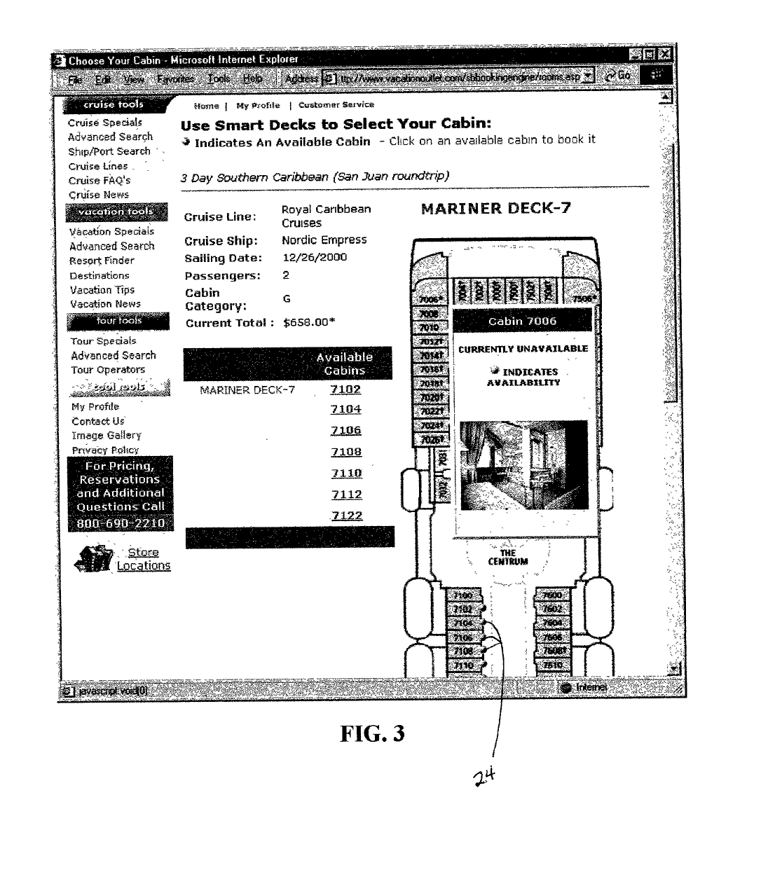

In the example shown in FIG. 3, cabin #7006 in the upper left corner of the Mariner Deck diagram was selected by the web browser user's mouse input device. This action causes the pop-up display window headed “Cabin 7006” to appear in the web browser window. The window indicates that cabin 7006 is currently unavailable for reservation. This functionality is based on the information that was pre-loaded in the user's web browser in the previous step. This step does not require the user's computer to make any additional information requests over the Internet to replace or update availability information—all the required information was provided by the time the “Example Step 1” screen (shown above) was rendered on the user's computer. As the user moves his mouse input device over the graphical representation of different cabins, new pop-up windows in the vicinity of the “moused-over” cabins are automatically generated to reflect the reservation availability of the newly indicated cabin.

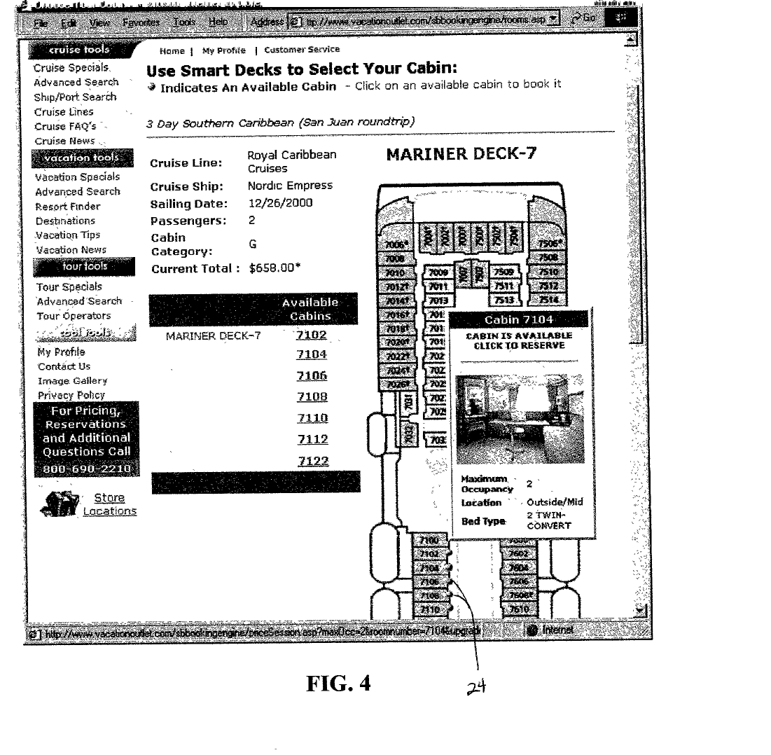

Web browser users may surmise what cabins in the display are available for reservation by noting which cabin representations include flashing dots. When the position of the browser user's mouse input device activates one of these specially-marked cabins, then the resulting pop-up window confirms reservation availability, and shows additional information. Such is the case for “Cabin 7104” in FIG. 4.

The web browser user may choose to continue with a reservation with respect to an available cabin by clicking on the cabin representation. At this point, the reservation request is sent from the user's web browser to reservation software over the Internet. The reservation request is recorded by the reservation software and used to generate a new page that is sent back to the user's web browser. The new page continues the cruise vacation reservation process. At this point, the cabin selection part of the cruise vacation reservation process is over and the user will complete the remainder of the process in a conventional manner.

After the user has selected a particular cabin, the user is asked for passenger names. When the user has entered this information, the web server places a 15 minute hold on the cabin, making it unavailable to other users. After the reservation process has been completed, a message is sent by the web server to the software system of the cruise line, and the availability information on the website is updated.

Thus, the web pages shown in FIGS. 2-4 provide the web browser user with a highly intuitive, graphical, information-rich tool for selecting a cabin reservation on a cruise ship for a particular sailing, scheduled for a particular date. The reservation availability information is current based on information provided by cruise line companies in real time over the Internet. The technology for this capability, called SmartDecks^{tm} technology is compatible with most widely used web browser software.

Inputting Data Into the System

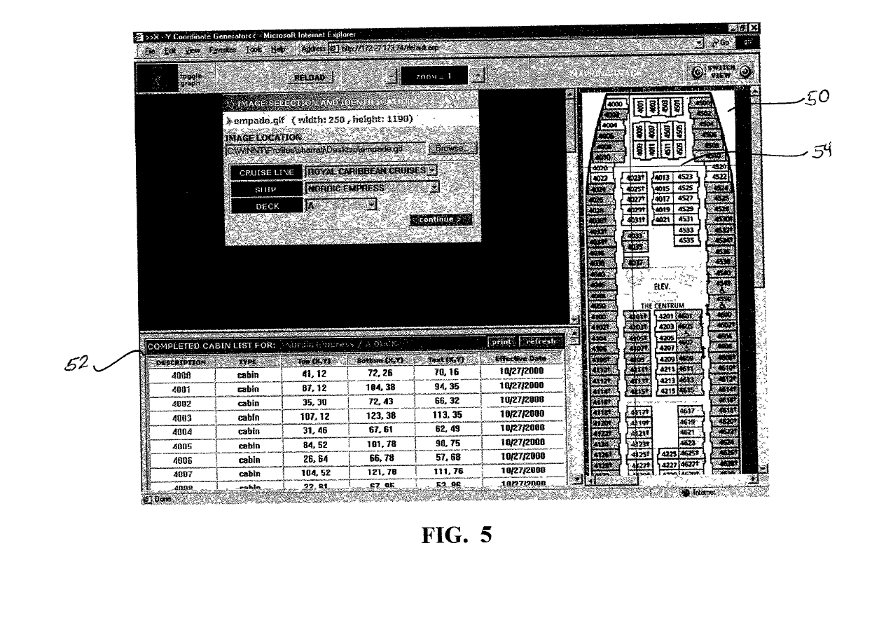

FIG. 5 shows an X-Y Coordinate Generator that may be used to specify the location of cabins with respect to an electronic version of a deck plan. An operator specifies the URL of the electronic deck plan, and the cruise line, ship and deck to which the plan corresponds, using the main menu. The deck image is loaded into the right-hand frame 50. A list of cabin coordinates (if any exist in the database) is loaded into the lower frame 52.

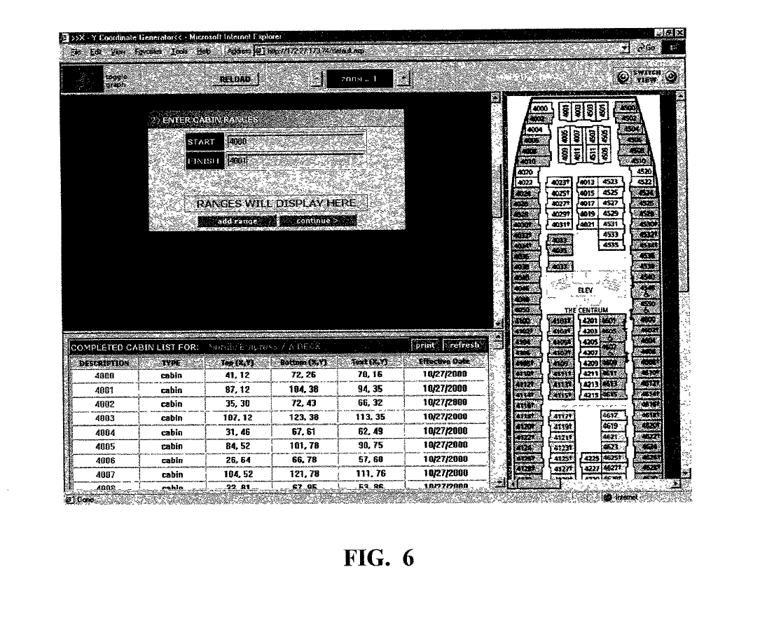

Next, the operator specifies the cabin ranges that the operator expects to add or alter, as shown in FIG. 6.

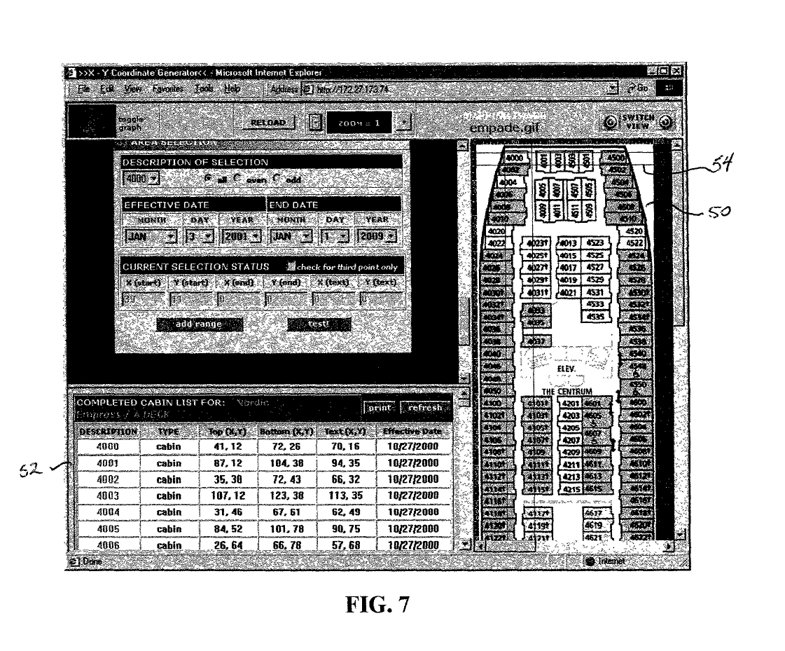

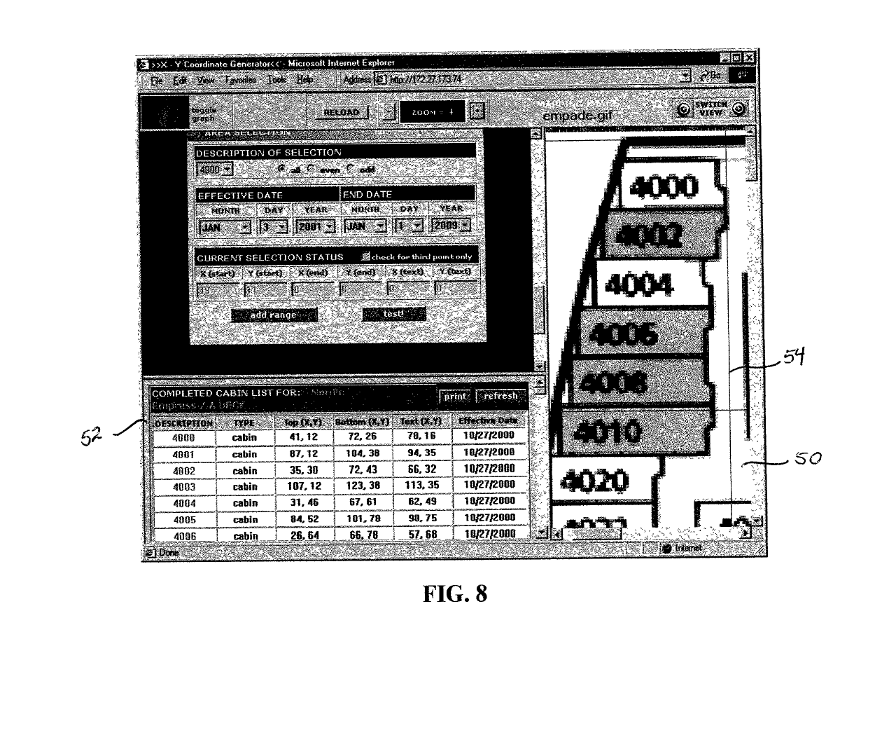

The operator then uses his mouse input device to train the red crosshairs 54 on the area that a cabin occupies. By doing so, the coordinates of the cabin relative to the plan are calculated and stored. If there is a mistake, the operator may repeat the crosshair placement after deleting the erroneous record in the bottom frame, as shown in FIG. 7. A zoom feature facilitates accurate cabin coordinate placement (FIG. 8).

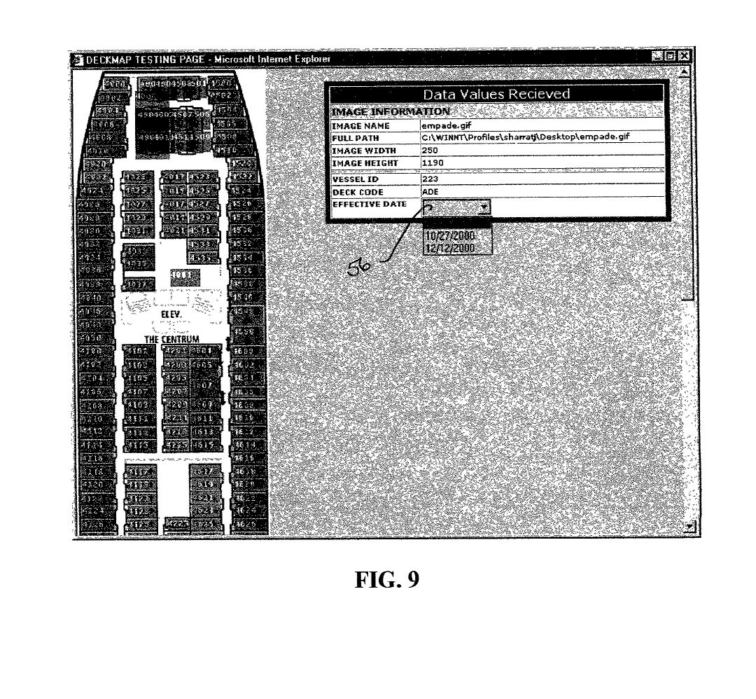

The operator may test his work by using the testing page shown in FIG. 9. In the example shown in FIG. 9, the coordinate mapping for cabin “4001” has been misplaced to show contrast. Upon inspection, the operator may verify that all other cabin coordinate mappings have been placed appropriately relative to the deck image. The Effective Date control 56 toggles the display to contrast updates made to the coordinate set on different dates.

The cabin coordinate data sets are then matched with per-cabin reservation availability status from cruise line vendor systems (provided in real-time over the Internet as discussed above), and additional descriptive content, e.g., regarding the features of the cabins, that is stored in a database 30 (FIG. 1) that is maintained by the website server 22. This information is combined and provided to the user's computer with display instructions that can be interpreted by any of the most widely-used web browsers.

Other embodiments are within the scope of the following claims.

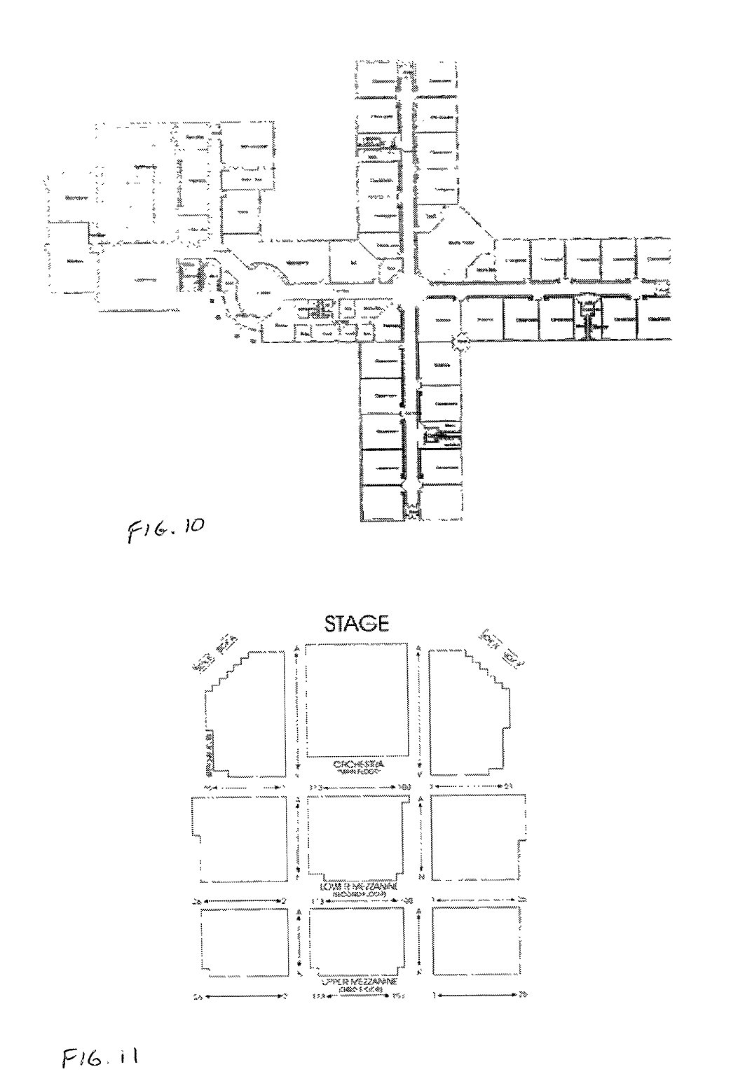

For example, the invention may be used in many other applications involving reservations, e.g., to manage reservations for hotel rooms, rental condos or spaces at a campground. In each case, a diagram of the space (hotel, condominium or campground) would be provided as discussed above, and users could click on a particular unit (room/condo unit/space) and obtain information regarding availability of that unit, and a view of the unit. An example of a plan for a hotel floor is shown in FIG. 10. The website may be configured so that when the user mouses over a particular unit a pop-up window showing a graphic image of that unit appears on the user's display.

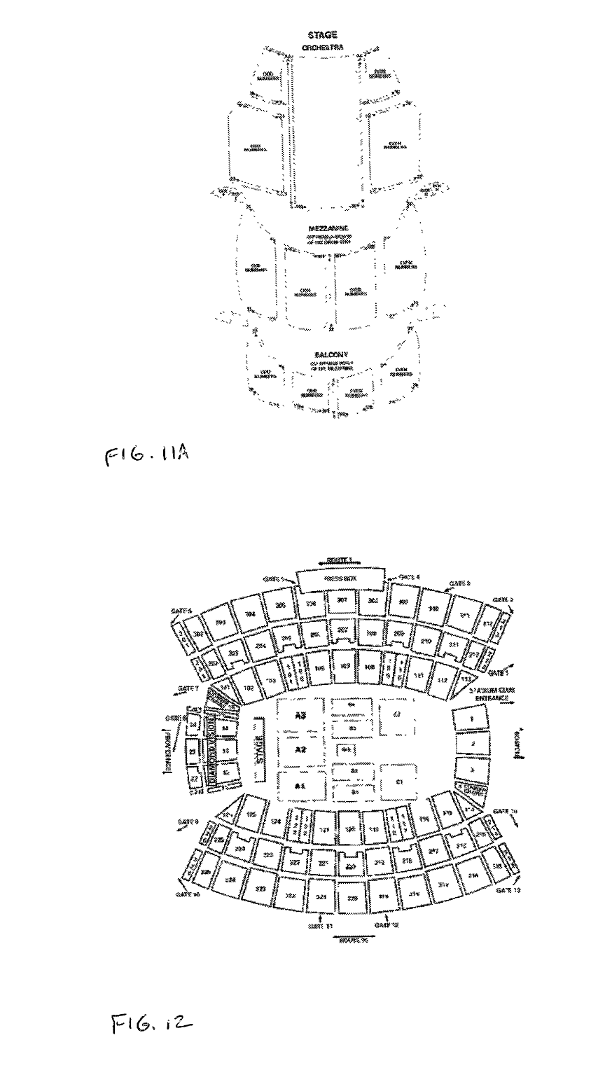

The invention may also be used to manage reservations for seats in a theatre or stadium, in which case the website may be configured to allow the user to click on a particular seat and view what a person seated in that seat would see. Examples of plans for theater and stadium seating are shown in FIGS. 11-11A and 12, respectively. The website can be configured to first provide the user with an overall diagram of the entire seating plan, as shown in FIGS. 11-12, and then, when the user clicks on a particular seating section, a detailed plan of that section showing individual seats. When the user mouses over a particular seat, a pop-up window showing a graphic representation of the stage view from that seat may be provided.

As another example, the invention may be used to manage reservations for seats in restaurants, e.g., popular upscale restaurants that require advance reservations and for which a restaurant-diner would like to be able to choose a particular seat in advance.

The availability state of a unit or seat may be indicated by a blinking light, as discussed above, or by any other suitable notation. For example, the background color of available units or seats may be different from that of units/seats that are unavailable.

What is claimed is:

1. A method comprising
displaying a plan of units located at a place of accommodation,
receiving from a user an interactive indication of a calendar period of interest,
receiving continually updated information about the availability for booking, during specified calendar periods, of units displayed on the plan, and
using the updated information to display in the vicinity of units on the plan an indicator of the availability state of units during the calendar period of interest.

2. The method of claim 1 further comprising displaying one indicator per unit.

3. The method of claim 1 further wherein the display is on a web browser.

4. The method of claim 1 wherein the place of accommodation comprises a lodging facility.

5. The method of claim 1 wherein the place of accommodation comprises a cruise ship.

6. The method of claim 1 wherein the units comprise cabins on a cruise ship.

7. The method of claim 1 wherein the plan comprises an image of a deck of a cruise ship.

8. The method of claim 1 wherein the place of accommodation comprises a hotel.

9. The method of claim 1 wherein the units comprise rooms or suites in a hotel.

10. The method of claim 1 wherein the plan comprises an image of a floor of a hotel.

11. The method of claim 1 further comprising displaying a graphic image of the interior of a unit when the user moves a pointer over the unit on the plan.

12. The method of claim 1 further comprising displaying textual information relating to features of a unit when the user moves a pointer over the unit on the plan.

13. The method of claim 1 wherein the plan comprises a seating arrangement.

14. The method of claim 13 wherein the seating arrangement is in a theatre, stadium or restaurant.

15. A method comprising
obtaining at least one plan of units for each of multiple places of accommodation, the different places of accommodation having different configurations,
making the plans of units available through a publicly accessible electronic network,
receiving continually updated information concerning the availability state of each of the units displayed on each plan during specified time periods, and
making the updated information available through the network so that it can be accessed by a user while viewing any of the plans of units.

16. The method of claim 15 wherein the network comprises the Internet.

17. The method of claim 15 wherein the places of accommodation comprise lodging facilities.

18. The method of claim 15 further including using the updated information to display an indicator in the vicinity of units on the plan of the availability state of units during a calendar period of interest.

19. The method of claim 15 wherein the plans of units comprise electronic representations of cruise ship decks.

20. A method comprising
obtaining an electronically represented plan of units for a place of accommodation,
displaying the plan, and
enabling a developer to interactively associate coordinates with each unit of the plan, to identify hot spots on which a user can position a pointer to obtain information associated with each unit.

21. The method of claim 20 wherein the information includes a graphic image of the interior of a unit.

22. The method of claim 20 wherein the information includes textual information relating to features of a unit.

23. The method of claim 20 wherein the information is provided in a pop-up window.

24. A method comprising
displaying, on a web browser, a plan of units located at a lodging facility,
receiving an interactive indication from a user of a calendar period of interest,
receiving continually updated information about the availability for booking of units displayed on the plan during specified calendar periods, and
using the updated information to display one indicator per unit in the vicinity of units on the plan of the availability state of units during the calendar period of interest.

25. The method of claim 24 wherein the lodging facility comprises a cruise ship and the units are cabins.

26. A method comprising
displaying a plan of units located at a place of accommodation,
displaying a graphic image of the interior of a unit when a user moves a pointer over the unit on the plan.

27. A method comprising
at a server, storing plans of accommodations available at different locations,
receiving at the server continually updated information about the availability of the accommodations at the different locations during defined time periods, and
making the plans and the continually updated information available on a publicly accessible communication network to customers for the accommodations.

28. A web page comprising
a plan of units of accommodation at a location, and
indicators on the plan in the vicinity of units of the accommodation, the indicators indicating the availability states of the units.
